(19) United States
(12) Patent Application Publication
(10) Pub. No.: US 2003/0075628 A1
(43) Pub. Date: Apr. 24, 2003

(54) Crusher apparatus

(75) Inventors: Rudolf Pretzler, Bruck/Mur (AT); Josef Heissenberger, Graz (AT)

Correspondence Address: Rocco S. Barrese, Esq., DILWORTH & BARRESE, LLP, 333 Earle Ovington Blvd., Uniondale, NY, 11553, US

(73) Assignee: Heissenberger & Pretzler GmbH

(21) Appl. No.: 10/273,933

(22) Filed: Oct. 18, 2002

(30) Foreign Application Priority Data
Oct. 18, 2001 (DE) 201 17 145.7
Jan. 28, 2002 (DE) 202 01 236.0

(51) Int. Cl. B02C 18/16

(52) U.S. Cl. 241/243

(57) ABSTRACT

The invention relates to a crusher apparatus, in particular for industrial waste and domestic waste-like materials, comprising a slowly running crusher roll which carries crusher tools distributed over the periphery and comprising counter-blade tools cooperating with the crusher tools which are arranged on a counter-blade tool carrier. In accordance with the invention, the crusher tools on the crusher roll and the counter-blade tools on the counter-blade tool are identical.

The invention relates to a crusher apparatus, in particular for industrial waste and domestic waste-like materials, in accordance with the preamble of claim 1.

Such crusher apparatuses are already known. They have a slowly running crusher roll, which carries crusher tools distributed over the periphery, and counter-blades which cooperate with the crusher tools and are arranged on a counter-blade tool carrier. The counter-blades on the counter-blade tool carrier form a biased contact comb with respect to the crusher roll with its crusher tools and the crusher tools arranged in the crusher roll mesh with these. When there is a foreign body load, i.e. when a hard foreign body occurs which is hard and which cannot be crushed by the crusher apparatus, for example a stone, the biased contact comb is pressed away such that the path is thereby made free for the foreign body. The bias is therefore pre-selected with this prior art such that the comparatively soft organic material can admittedly be reliably crushed, but that, when a stone or another hard object occurs which could damage the blades, the counter-blade tool carrier with the counter-blades can be moved away out of an engagement position. However, it is a disadvantage with this prior art that the foreign body moves along into the crushed material. Furthermore, the crusher tools and the counter-blades are worn by a frequent occurrence of foreign bodies.

A solution of the generic kind has become known from the German utility model 298 09 078 in which the crusher roll can be stopped for the event that a limiting torque is exceeded when a foreign body enters into the crusher region. When this limiting torque is reached, the counter-blade unit is pivoted away as a whole from the crusher roll via a piston-in-cylinder arrangement. The foreign body can now be removed without it wearing the crusher tools.

With the already known prior art, however, both the crusher roll and the counter-blade unit have a comparatively complex design.

It is the object of the invention to further develop a crusher apparatus of the generic kind such that the design is simplified, with in particular also the stock keeping of the wear parts to be replaced being simplified as much as possible and being kept low.

In accordance with the invention, this object is solved, starting from a crusher apparatus of the generic kind in accordance with the preamble of claim 1, by the combination with the characterising features of claim 1. Accordingly, both the crusher tools on the crusher roll and the counter-blade tools on the counter-blade tool carrier have an identical design.

A simplified design, and in particular a substantially simplified stock keeping for the tools, is hereby provided since only one tool type has to be kept in stock which can be used both as a crusher tool on the crusher roll and as a counter-blade tool on the counter-blade tool carrier.

Special aspects of the invention result from the dependent claims following on from the main claim.

For instance, in accordance with a first preferred aspect of the invention, the counter-blade tools are arranged offset to one another on the counter-blade tool carrier. The cutting or tearing force is hereby minimised since first a counter-blade tool is passed and then the adjacent counter-blade tool is passed here via the engagement of the crusher tool. An offset cut with smaller force peaks is hereby achieved.

In accordance with a further preferred embodiment of the invention, rails can be arranged on the counter-blade tool carrier such that they axially transport the material to be crushed in the compacting process. For this purpose, the rails arranged on the counter-blade tool carrier can be set obliquely.

To improve the material feed, the crusher tools on the crusher roll can be arranged in a spiral shape next to one another.

The cutting gap adjustment between the crusher roll and the counter-blade unit, which consists substantially of the counter-blade tool carrier and the counter-blade tools, can be adjustable via two wedges each arranged at the side. The wedges can be moved to the inside and to the outside by two synchronously connected hydraulic cylinder units. The movement hereby takes place coaxially to the crusher roll, with the counter-surfaces of the wedges being designed fixed to the frame. To achieve the adjustment of the cutting gap by pivoting the total counter-comb, the wedges are pushed continuously onto the counter-surfaces fixed to the frame. To ensure a full-area contact of the wedges, these can be guided cylindrically in the guides and be freely rotatable so that they can respectively align themselves to the surface of the areal contact.

Additional scrapers can be provided which engage between the crusher tools arranged on the crusher roll.

The counter-blade tool or the crusher tool can substantially correspond in a projection to an equilateral triangle in which projecting teeth are formed in the rounded corners of the triangle.

The crusher tool or the counter-blade tool can be respectively fixable on a corresponding holding apparatus via a single screw, with it being secured against rotation via a shape matching.

The crusher tool and the counter-blade tool can quite particularly advantageously be able to be installed in a manner rotatable by 120° in each case with respect to the holding apparatus.

Further details and advantages of the invention will be explained in more detail with reference to an embodiment shown in the drawing. There are shown:

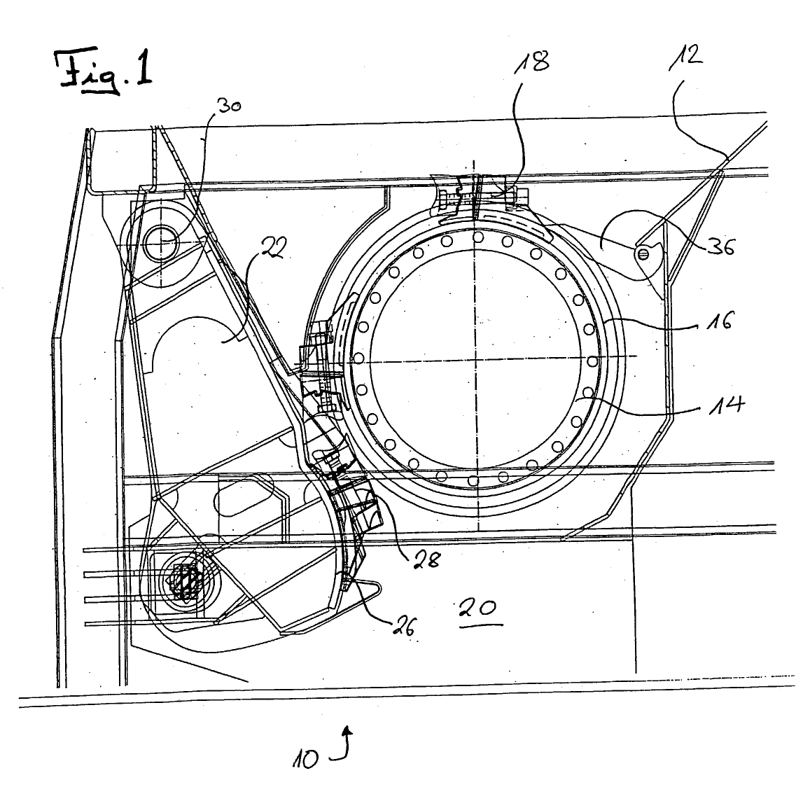

FIG. 1: a schematic representation of the crusher apparatus in accordance with a preferred embodiment of the invention;

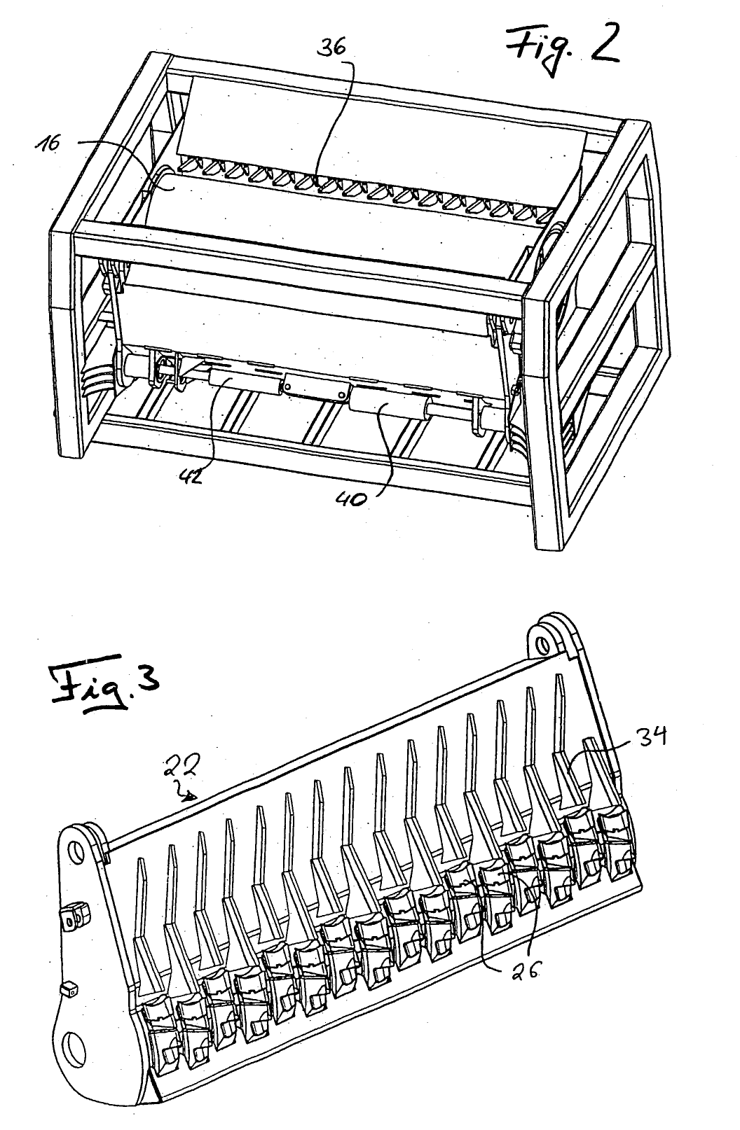

FIG. 2: a perspective view of the crusher apparatus;

FIG. 3: a perspective view of the counter-blade unit of the crusher apparatus in accordance with claim 2;

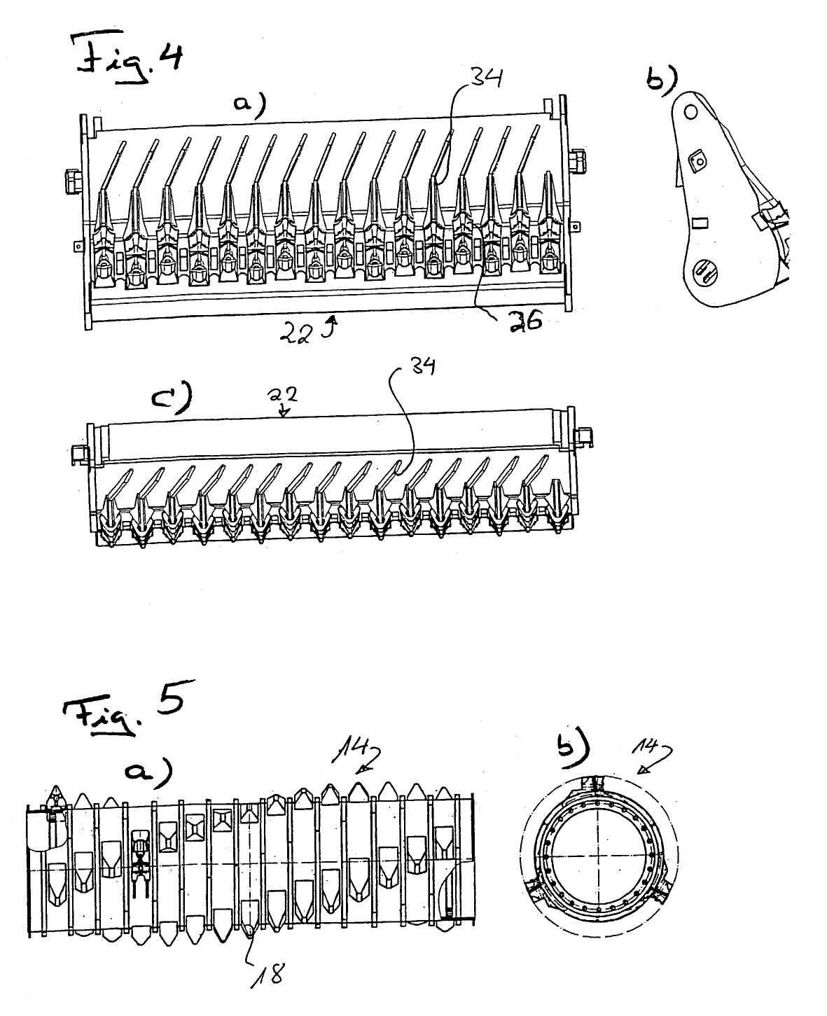

FIGS. 4a, b, c: respectively a side view, a plan view and a view from the front of the counter-blade unit of FIG. 3;

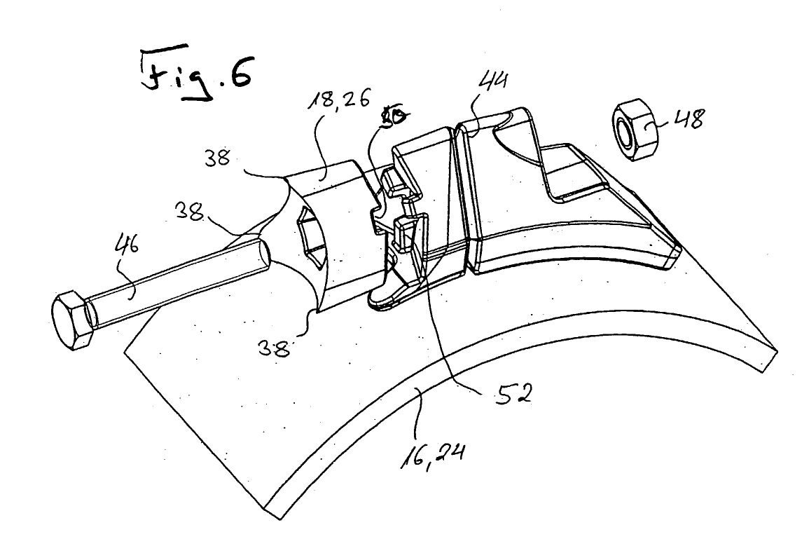

FIGS. 5a, b: a side view and a plan view of a crusher roll of the crusher apparatus in accordance with the invention; and

FIG. 6 a detail of a crusher tool in an exploded view.

A crusher apparatus 10 is shown in FIG. 1 which can be installed on a truck, for example. The crusher apparatus has a hopper 12 for the pouring in of the material to be crushed, for example organic material. First, a slowly running crusher roll 14 having a roll base body 16 and crusher tools 18 is arranged below the hopper 12. A receiving space 20 for the crushed material and a conveyor belt, not shown in more detail here, for the transporting away of the crushed material are arranged below the crusher roll 14. The crusher roll 14 cooperates in a manner known per se with a counter-blade unit 22 which consists of a counter-blade tool carrier 26 and counter-blade tools 28 arranged on this. In this connection, the crusher tools 18 mesh with the counter-blade tools 28. The whole counter-blade unit is pivotably mounted about a spigot 30 for the gap adjustment between the counter-blade tools 26 and the crusher tools 18.

The pivoting of the counter-blade unit takes place via two wedges, not shown in any more detail in the present illustration, which are moved to the inside and to the outside via two synchronously connected hydraulic piston-in-cylinder units 40 and 42 respectively—shown in FIG. 2—such that they slide off counter-surfaces which are likewise not shown in the drawing, which are made fixed to the frame and thus allow a pivoting of the counter-blade unit 22 in the direction of gravity. If the wedges are fully retracted, that is no longer stand in engagement with the corresponding counter-surfaces, the counter-blade unit 22 pivots downwards in the direction of gravity so that the whole counter-blade unit 22 is no longer in engagement with the crusher roll. To ensure an areal contact of the wedges, these are guided cylindrically in grooves—in a manner likewise not show in any more detail—and can thus be freely rotated such that they can adapt to their contact surface.

Scrapers 36, which are shown in particular from FIG. 1 and from the perspective representation in accordance with FIG. 2 and which are arranged next to one another, cooperate with the crusher roll 14. In the perspective illustration in accordance with FIG. 2, the crusher tools 18 on the roll base body 16 have been omitted for reasons of simplicity.

The counter-blade unit 22 is shown separately in FIGS. 3 and 4a, b, c. It becomes clear from this representation that the counter-blade tools 26, which are respectively adjacent, are arranged offset with respect to the respectively following counter-blade tools. In this connection, the offset is here arranged alternately. Rails 34 are arranged next to one another above the counter-blade tools 26 and extend over a part of their length obliquely towards the counter-blade tools 26.

In FIG. 5, the crusher roll 14 is shown in the representations a and b, with a plurality of rows of crusher tools 18 arranged spirally with respect to one another being applied here.

It becomes clear from FIG. 6 how the respective tools are designed. Since these have an identical design, they can be a crusher tool 18 or a counter-blade tool 26 in FIG. 6. The counter-blade tool 18 and/or the crusher tool 26 is, in its projection, substantially an equilateral triangle with rounded corners. As is clear from the perspective representation in accordance with FIG. 6, projecting teeth 38 are formed in the region of the rounded corners. The crusher tool 18 and/or the counter-crusher tool 26 are held on a corresponding holder 44, with the holding device 44 being made in two parts in the embodiment shown. Both parts 44 are welded to the roll base body 16 or to the counter-blade tool carrier 24. The counter-blade tool and the crusher tool are fastened to the holding device 44 via a single screw 46 and held by means of a nut 48. Spigots 52 of the holding device 44 engage in a shape-matched manner via cut-outs 50 in the crusher tool 18 or in the counter-blade tool 26.

In this connection, as shown in FIG. 6, these are three spigots 52 which are arranged symmetrically. Due to the corresponding arrangement, as is shown in FIG. 6, the tool can be rotated about 120° in each case after the wear of one of the teeth 38 such that here all cutting teeth 38 can be uniformly worn one after the other. The service life of the crusher tool 18 and/or of the counter-blade tool 26 can be substantially extended by this arrangement.

1. A crusher apparatus, in particular for industrial waste and domestic waste-like materials, comprising a slowly running crusher roll which carries crusher tools distributed over the periphery and comprising counter-blade tools cooperating with the crusher tools which are arranged on a counter-blade tool carrier,
characterised in that the crusher tools on the crusher roll and the counter-blade tools on the counter-blade tool carrier are identical.

2. A crusher apparatus in accordance with claim 1, wherein the counter-blade tools are arranged offset to one another on the counter-blade tool carrier.

3. A crusher apparatus in accordance with claim 1 or claim 2, wherein rails are arranged on the counter-blade tool carrier such that they axially transport the material to be crushed in the compacting process.

4. A crusher apparatus in accordance with any of claims 1 to 3, wherein the crusher tools on the crusher roll are arranged in spiral form next to one another.

5. A crusher apparatus in accordance with any of claims 1 to 4, wherein the cutting gap adjustment between the crusher roll and the counter-blade unit substantially consisting of the counter-blade tool carrier and the counter-blade tools can be adjusted via two wedges respectively arranged at the side.

6. A crusher apparatus in accordance with claim 5, wherein the wedges are displaceable with respect to an incline, fixed to the frame, via two piston-in-cylinder units which can be controlled synchronously to one another in order to thus adjust the cutting gap.

7. A crusher apparatus in accordance with any of claims 1 to 6, wherein additional scrapers are provided which engage between crusher tools arranged on the crusher roll.

8. A crusher apparatus in accordance with any of claims 1 to 7, wherein the counter-blade tool and/or the crusher tool substantially corresponds in its projection to an equilateral triangle and wherein projecting teeth are formed in the rounded corners of the triangle.

9. A crusher apparatus in accordance with claim 8, wherein the crusher tool and/or the counter-blade tool can be fixed on a corresponding holding apparatus via a single screw, with it being secured against rotation by shape-matching.

10. A crusher apparatus in accordance with claim 8 or claim 9, wherein the crusher tool and the counter-blade tool can each be installed rotatably by 120° with respect to the holding apparatus.
